(19) United States
(12) Patent Application Publication
(10) Pub. No.: US 2020/0324151 A1
(43) Pub. Date: Oct. 15, 2020

(54) VALVE MEMBRANE

(71) Applicant: UVEX ARBEITSSCHUTZ GMBH, Fürth (DE)

(72) Inventors: Wolf WAGNER, Cadolzburg (DE); Manfred SCHUSTER, Röthenbach (DE); Florian KÜHNLEIN, Fürth (DE)

(21) Appl. No.: 16/094,610

(22) PCT Filed: Apr. 13, 2017
(86) PCT No.: PCT/EP2017/058979

§ 371 Date: Oct. 18, 2018

(30) Foreign Application Priority Data
Apr. 21, 2016 (DE) 10 2016 206 775.3

(51) Int. Cl. A62B 18/02; A62B 18/10

(52) U.S. Cl. CPC A62B 18/025; A62B 18/10

(57) ABSTRACT

A breathing mask for filtering air exhaled by a wearer of the breathing mask. The breathing mask includes a mask main body for covering the nose and mouth of the wearer, and at least one breathing valve arrangement which is arranged on the mask main body and includes a valve seat body and a valve membrane that is movable between a release position and a closed position, which valve membrane frees a breathing opening in the release position, closes the breathing opening in the closed position, and includes a reinforcement structure with at least one oblique reinforcement body extending obliquely with respect to a central plane of the valve membrane.

### CROSS REFERENCE TO RELATED APPLICATIONS

This application is a United States National Phase Application of International Application PCT/EP2017/058979 filed Apr. 13, 2017 and claims the benefit of priority under 35 U.S.C. § 119 of German Patent Application, Serial No. DE 10 2016 206 775.3 filed Apr. 21, 2016, the entire contents of which are incorporated herein by reference.

### FIELD OF THE INVENTION

The invention is directed to a valve membrane for a breathing mask. The invention further relates to a breathing mask for filtering air exhaled by the wearer of the breathing mask.

Breathing masks are generally known through prior public use and are used in particular in the field of occupational safety, although other areas of use are of course also possible. Breathing masks have proven useful in practice. A disadvantage of the breathing masks of the prior art is that the wearer of the breathing mask often finds that breathing, in particular breathing out, feels uncomfortable or even difficult.

### BACKGROUND OF THE INVENTION

A fluid valve of the generic type for use in a filter mask is known from EP 0 756 881 A2. The valve comprises a flexible trapezoidal flap, which is curved transversely to ensure it will remain seated on the valve seat even in the absence of a differential pressure. Breathing is often felt to be uncomfortable when using this valve.

A valve for a diving mask, which has a triangle-shape valve plate, is known from U.S. Pat. No. 6,834,649 B1. This valve does not always work safely.

DE 1 213 249 A discloses breathing masks with valves. Each valve comprises a disk-shaped, flexible valve closure body.

US 2012/0167890 A1 discloses breathing masks with exhalation valves. Each exhalation valve has a membrane with specially adapted regions.

US 2015/0136141 A1 discloses a breathing apparatus with an exhalation valve which has a flexible membrane with a reinforcement arrangement.

### SUMMARY OF THE INVENTION

The object of the invention is to make available a valve membrane which allows the wearer of the breathing mask to breathe, in particular breathe out, in an easy and natural way. Moreover, the valve membrane is intended to provide a very high degree of safety. A corresponding breathing mask is also intended to be provided.

This object is achieved, according to the invention, by a valve membrane for a breathing mask, comprising a reinforcement structure with a plurality of oblique reinforcement bodies extending obliquely with respect to a central plane of the valve membrane, wherein at least two of the oblique reinforcement bodies each run together in a V shape so as to form at least one V-shaped reinforcement arrangement, wherein a plurality of the V-shaped reinforcement arrangements are present, wherein at least two of these are connected to each other via at least one reinforcement connection body of the reinforcement structure lying in the central plane of the valve membrane, wherein the reinforcement connection body is formed by a central connection web, and wherein the valve membrane is triangle-shaped.

Furthermore, this object is achieved by a breathing mask for filtering air exhaled by a wearer of the breathing mask, said breathing mask comprising a mask main body for covering a nose and mouth of the wearer, and at least one breathing valve arrangement which is arranged on the mask main body and comprises a valve seat body and a valve membrane that is movable between a release position and a closed position, which valve membrane is triangle-shaped, frees at least one breathing opening in the release position, closes the at least one breathing opening in the closed position, and comprises a reinforcement structure with a plurality of oblique reinforcement bodies extending obliquely with respect to a central plane of the valve membrane, wherein at least two of the oblique reinforcement bodies each run together in a V shape so as to form at least one V-shaped reinforcement arrangement, wherein a plurality of the V-shaped reinforcement arrangements are present, wherein at least two of these are connected to each other via at least one reinforcement connection body of the reinforcement structure lying in the central plane of the valve membrane, and wherein the reinforcement connection body is formed by a central connection web.

The core aspect of the invention is that the breathing mask comprises at least one breathing valve arrangement through which in particular the wearer breathes in and/or out while wearing the breathing mask. By virtue of the reinforcement structure of the valve membrane, particularly easy breathing is possible via the at least one breathing valve arrangement, wherein at the same time it is possible to achieve extremely safe and fluid-tight closure of the at least one breathing opening or of at least one breathing channel through the valve membrane.

The valve membrane is triangle-shaped. Here, the expression “triangle-shaped” is also understood as meaning a substantially triangular shape with, for example, at least one rounded corner and/or at least one curved side or edge.

A large number of oblique reinforcement bodies are present. For example, between five and thirty oblique reinforcement bodies are present.

At least two of the oblique reinforcement bodies run together in a V shape so as to form at least one V-shaped reinforcement arrangement.

The expression “V shape” or “V-shaped reinforcement arrangement” is also understood to mean substantially V-shaped arrangements in which, for example, at least one of the arms of the V is curved and/or is composed of individual portions extending obliquely with respect to each other. Moreover, the expression is also understood to mean arrangements having a curved tip of the V.

A plurality of the V-shaped reinforcement arrangements are present, in particular between three and fifteen of them, wherein at least two, preferably some, preferably most, preferably all of the V-shaped reinforcement arrangements are connected to each other via at least one reinforcement connection body of the reinforcement structure lying in the central plane of the valve membrane. Precisely one reinforcement connection body is expediently present. The reinforcement connection body can assume any desired shape.

The connection web expediently extends along the central plane or plane of symmetry of the valve membrane. It expediently forms a stem to which at least some, preferably several, preferably all of the oblique reinforcement bodies are obliquely attached at the sides.

The minimum stiffness of the reinforcement structure is preferably determined by a requirement concerning a minimum stiffness of the valve membrane. This minimum stiffness is preferably chosen such that the valve membrane in its closed position bears on the valve seat body in a fluid-tight manner and completely closes the at least one breathing opening in a fluid-tight manner, for example even when the valve membrane is sloping downward. The valve membrane preferably does not sag.

It is advantageous if the valve membrane has a Shore A hardness of between 45 and 75.

It is expedient if the valve membrane bulges forward or is pretensioned. This ensures in particular that the valve membrane has a certain stiffness and, independently of its orientation, does not sag, for example under the effect of the prevailing force of gravity.

The reinforcement structure is expediently an integral component of the valve membrane. It is expedient if the reinforcement structure is wholly contiguous.

The valve membrane is expediently symmetrical with respect to the central plane of the valve membrane, which preferably divides the valve membrane into two identical halves and/or runs perpendicular to a main plane of the valve membrane in which the valve membrane lies flat. The central plane of the valve membrane thus expediently forms a plane of symmetry.

The valve membrane in the reinforcement structure expediently has a thickness, perpendicular to the main plane of the valve membrane, of between 0.3 mm and 0.5 mm. Otherwise, the valve membrane preferably has a thickness that is approximately half as thick as in the reinforcement structure or of between 0.1 mm and 0.3 mm. The reinforcement structure preferably has a uniform thickness. The thickness of the valve membrane at a distance from the reinforcement structure is preferably also uniform.

It is advantageous if the valve membrane has, at least in part, a varying thickness perpendicular to the main plane of the valve membrane. In particular, the thickness of the valve membrane decreases from one end of the valve membrane to an opposite end of the valve membrane. The thickness at the central connection web expediently decreases from an edge-side connection panel in the direction of the tip of the valve membrane, expediently from 0.4 mm to 0.6 mm to 0.25 mm to 0.45 mm.

The at least one oblique reinforcement body preferably has a web-like configuration. It preferably has substantially an at least mostly uniform breadth or width in the main plane of the valve membrane. For example, the at least one oblique reinforcement body encloses, with the central plane of the valve membrane, an angle of between 10° and 50°, preferably of between 20° and 40°.

It is expedient if the valve membrane is an injection molding injected from a plastic material. Such a valve membrane can be produced cost-effectively and exactly. Alternatively, the valve membrane is produced by hot embossing or punching, which likewise permits cost-effective and exact manufacture thereof. The valve membrane is formed, for example, of silicone, TPU (thermoplastic polyurethane) or TPR (thermoplastic rubber).

It is advantageous if the at least one breathing valve arrangement is configured as a disposable valve arrangement.

The breathing valve arrangement is preferably configured as an exhalation valve arrangement, such that the wearer of the breathing mask in particular exhales via the at least one breathing valve arrangement.

The valve membrane is then preferably moved automatically or independently by the exhalation of the wearer of the breathing mask. In particular, a specific movement of the valve membrane takes place. After the exhalation by the wearer, the valve membrane returns preferably automatically or independently to its previous position.

In its closed position, the valve membrane preferably closes the at least one breathing opening at least partially, more preferably completely. It then expediently bears on the valve seat body in such a way that the at least one breathing opening is closed completely by the valve membrane. It extends preferably completely in the main plane of the valve membrane or is then for example curved at least in part.

It is advantageous if, in its release position, the valve membrane frees the at least one breathing opening at least partially, preferably completely, such that the wearer's breath can flow through the at least one breathing opening. It is then expediently lifted away from the valve seat body at least in part.

The mask main body is expediently formed from a non-woven material. It is advantageous if the wearer of the breathing mask inhales through the mask main body itself. The mask main body is expediently formed from an air-permeable filter material.

Alternatively, the breathing valve arrangement is configured as an inhalation valve arrangement. The inhalation valve arrangement then allows particularly easy inhalation by the wearer. The mask main body is then preferably formed from an air-impermeable material.

The mask main body expediently has a shell-like configuration. For example, it has a sealing lip for resting on the wearer or on the wearer's face.

It is advantageous if the valve seat body is closed at the periphery. It expediently delimits the at least one breathing opening. The shape of the valve seat body is preferably adapted to the valve membrane. In particular, the valve seat body has an inner or central support structure which at least in part supports the valve membrane, in its closed position, at a distance from the edge thereof and thus, for example, prevents the valve membrane from sagging in its closed position.

It is advantageous if the whole breathing mask is configured symmetrically with respect to a plane of symmetry.

The breathing mask is preferably configured as a half mask. Other configurations, for example a full-face breathing mask, are alternatively possible. The breathing mask preferably filters particles or is usable in the presence of gases or vapor.

The breathing mask expediently comprises at least one retaining means, such as a head band, for holding the breathing mask on the wearer's head.

It is advantageous, in a preferred embodiment of the valve membrane, if the reinforcement structure adjoining valve membrane portions of the valve membrane protrudes relative to the valve membrane portions in at least one direction perpendicular to the main plane of the valve membrane. The reinforcement structure is preferably connected in one piece to the valve membrane portions. The valve membrane portions preferably have a uniform thickness, for example of between 0.1 mm and 0.3 mm.

In accordance with another preferred embodiment of the valve membrane, at least some, preferably at least most, preferably all of the valve membrane portions, in a main plane of the valve membrane, are broader at least in part than the at least one respective oblique reinforcement body.

In accordance with another preferred embodiment of the valve membrane, the valve membrane expediently has at least one predetermined bending point or predetermined bending line at a distance from and/or adjacent to the reinforcement structure, about which bending point or bending line the valve membrane bends during its movement between the release position and closed position. At the at least one predetermined bending point, the valve membrane expediently has a reduced bending resistance. The at least one predetermined bending point also expediently intersects the reinforcement structure. It is preferably straight, curved or substantially V-shaped.

These observations apply analogously to the preferred embodiment according to which the reinforcement structure defines at least one predetermined bending point of the valve membrane.

The frame body of the reinforcement structure configured such as to completely surrounding the valve membrane expediently extends at the edge to the valve membrane.

In accordance with another preferred embodiment of the valve membrane, the reinforcement connection body is formed by a central connection panel that extends at the edge. It is expedient if at least some, preferably several, preferably all of the oblique reinforcement bodies are joined to this connection panel, in particular at an angle.

Some oblique reinforcement bodies can be joined to the connection web and other oblique reinforcement bodies to the connection panel.

It is expedient if the valve membrane is fixed in position in the region of the connection panel, in particular clamped. It is advantageous if at least one clamping or fixing means of the valve membrane is arranged in the central connection panel. It is expediently configured as an opening or web. It is preferably arranged adjacent to the base or base side of the valve membrane.

At least some, preferably most, preferably all of the oblique reinforcement bodies expediently extend obliquely outward or obliquely forward from a base of the valve membrane or from the connection panel. It is advantageous if at least some, preferably most, preferably all of the oblique reinforcement bodies extend at an angle to a base or base side of the valve membrane.

It is expedient if at least some, preferably most, preferably all of the oblique reinforcement bodies extend in a radiating pattern or radially away from the base or the central connection panel of the valve membrane.

In accordance with another preferred embodiment of the valve membrane, at least two, preferably most, preferably all of the V-shaped reinforcement arrangements are connected to each other via at least one auxiliary reinforcement web extending at a distance from the central plane or plane of symmetry of the valve membrane. It is advantageous if the at least one auxiliary reinforcement web is curved at least in part and/or extends obliquely with respect to the central plane or plane of symmetry of the valve membrane.

It is advantageous if the central connection web and the at least one auxiliary reinforcement web extend anti-parallel to each other at least in part.

The present invention is described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a plan view of a breathing mask according to the invention;

FIG. 2 is a longitudinal sectional view through a breathing valve arrangement of the breathing mask shown in FIG. 1, the valve membrane thereof being located in a closed position;

FIG. 3 is a view corresponding to FIG. 2, the valve membrane being located in a release position;

FIG. 4 is an isolated plan view of the valve membrane already shown in FIGS. 1 to 3;

FIG. 5 is an enlarged longitudinal sectional view through the valve membrane shown in FIG. 4, along the section line V-V;

FIG. 6 is an enlarged longitudinal sectional view through the valve membrane shown in FIG. 4, along the section line VI-VI; and

FIG. 7 is a plan view of a further valve membrane which, for example, can also be used alternatively in the breathing valve arrangement shown in FIGS. 1 to 3;

FIG. 8 is a plan view of a further valve membrane which, for example, can also be used alternatively in the breathing valve arrangement shown in FIGS. 1 to 3; and

FIG. 9 is plan view of a further valve membrane which, for example, can also be used alternatively in the breathing valve arrangement shown in FIGS. 1 to 3.

### DESCRIPTION OF THE PREFERRED EMBODIMENTS

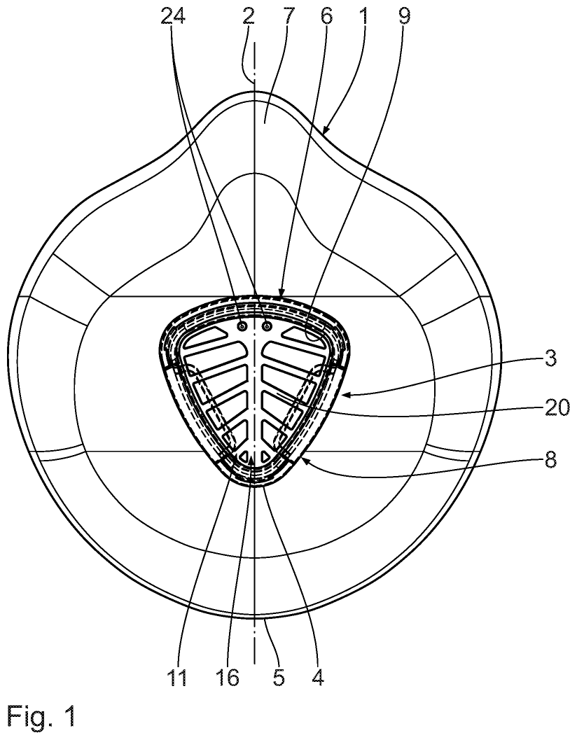

A breathing mask shown in its entirety in FIG. 1, and designed as a half mask, is symmetrical with respect to a plane of symmetry 2.

The breathing mask comprises a mask main body 1. When the mask main body 1 is worn as intended by a wearer (not shown), it covers a nose region and mouth region of the wearer. Head bands (not shown) are guided round the back of the wearer's head.

In a central region, the breathing mask has an exhalation valve arrangement 3, which is substantially triangle-shaped in cross section. The exhalation valve arrangement 3 is assigned to an exhalation opening (not shown) arranged in the mask main body 1. It is secured on the mask main body 1. A tip 4 of the exhalation valve arrangement 3 is directed toward a chin region 5 of the mask main body 1, while a base 6 of the exhalation valve arrangement 3 is directed toward a nose region 7 of the mask main body 1. Another orientation is alternatively possible.

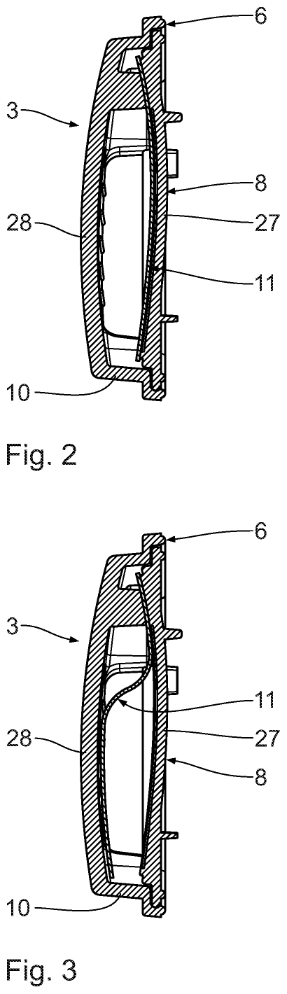

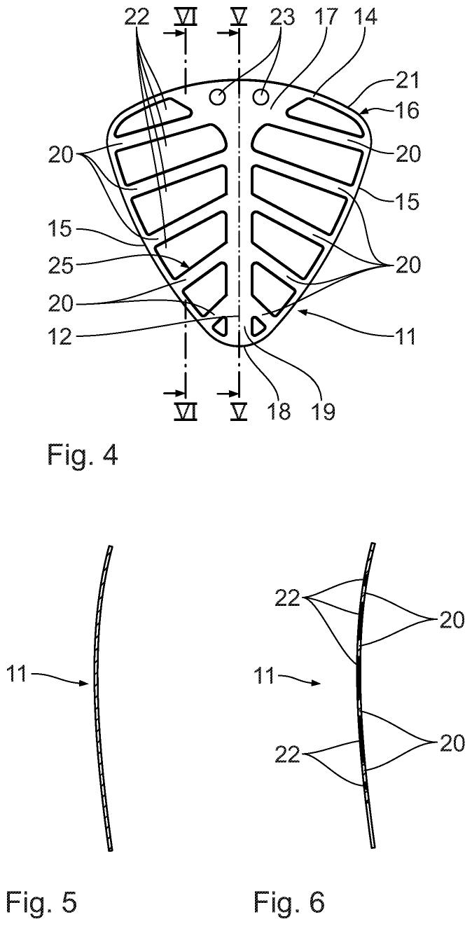

Referring now also to FIGS. 2 and 3, the exhalation valve arrangement 3 has a valve seat body 8, which delimits or has a valve seat opening 9 and is secured on the mask main body 1. In the assembled state of the exhalation valve arrangement 3, the valve seat opening 9 is coincident with the breathing opening in the mask main body 1. The valve seat body 8 additionally has a central support structure 27 with a plurality of support webs.

Moreover, the exhalation valve arrangement 3 has a housing body 10 which, in the assembled state of the exhalation valve arrangement 3, is arranged externally with respect to the mask main body 1 and is secured on the valve seat body 8 and/or the mask main body 1. The housing body 10 has a roof 28, which is arranged at a distance from the valve seat body 8 and covers the valve seat opening 9.

Moreover, the exhalation valve arrangement 3 has a flexible valve membrane 11 which is injected from a plastic material and is itself impervious to fluid. The valve membrane 11 is clamped in part at the edge between the valve seat body 8 and the housing body 10. Another region of the valve membrane 11 is movable between a closed position (FIG. 2) and a release position (FIG. 3). As FIG. 2 shows, the valve membrane 11 in its closed position bears in a fluid-tight manner on the valve seat body 8 and completely closes the valve seat opening 9 in a fluid-tight manner. In particular, an inhalation of ambient air through the exhalation valve arrangement 3 is thus completely suppressed.

When the wearer of the breathing mask exhales, the valve membrane 11 is lifted in part away from the valve seat body 8 at a distance from its clamping site, such that the valve seat opening 9 is freed and the wearer's breath can flow through the valve seat opening 9 and escape via respiration outlet openings (not shown) formed in the housing body 10. The valve membrane 11 then lies in part on the inside of the roof 28. The roof 28 prevents further movement of the valve membrane 11. When the wearer of the breathing mask is no longer exhaling, the valve membrane 11 returns automatically to its closed position.

The outer shape of the valve membrane 11 is adapted to the valve seat body 8, or to the valve seat thereof. It is triangle-shaped, the corners being rounded and the sides curved.

The valve membrane 11 is itself symmetrical with respect to a central plane or plane of symmetry 12 of the valve membrane. In a plan view, the central plane 12 of the valve membrane divides the valve membrane 11 into two identical halves and extends substantially perpendicularly with respect to a main plane of the valve membrane in which the valve membrane 11 lies in a flat position. The valve membrane 11 has a curved base 14 and two curved sides 15 which adjoin the base 14 and which run together from the base 14.

The valve membrane 11 has a reinforcement structure 16 with a central connection panel 17 arranged adjacent to the base 14, with a connection web 19 extending in a straight line from the connection panel 17 to a tip 18 lying opposite the base 14, and with oblique reinforcement bodies 20 which extend laterally and obliquely outward from the connection panel 17 and the connection web 19 with respect to the central plane 12 of the valve membrane. Starting from the central plane 12 of the valve membrane, the oblique reinforcement bodies 20 extend obliquely forward or obliquely away from the base 14. Two clamping openings 23 are provided in the connection panel 17. In the assembled state of the valve membrane 11, fixing webs 24 of the valve seat body 8 and/or of the housing body 10 engages in or through the clamping openings 23, as a result of which the valve membrane 11 is further fixed in position. The reinforcement structure 16 moreover comprises an edge-side frame body 21, which is closed about the periphery.

In the main plane of the valve membrane, the connection web 19 has a much greater width than the respective oblique reinforcement bodies 20, which have a uniform width.

Oblique reinforcement bodies 20 lying opposite each other together form a V-shaped reinforcement arrangement 25. In total, there are between three and eight V-shaped reinforcement arrangements 25, in this case five of them. The oblique reinforcement bodies 29 extending on a common side with respect to the connection web 19 run parallel to each other. Precisely one V-shaped reinforcement arrangement 25 is joined to the connection panel 17. The individual V-shaped reinforcement arrangements 25 are arranged offset in relation to each other.

Starting from the connection panel 17, the length of the oblique reinforcement bodies 20 decreases on account of the triangle-shaped configuration of the valve membrane 11.

The reinforcement structure 16 expediently has a uniform thickness perpendicular to the main plane of the valve membrane.

The valve membrane 11 has thin valve membrane portions or panels 22 between the reinforcement structure 16. The valve membrane portions 22, perpendicular to the main plane of the valve membrane, are substantially thinner than the reinforcement structure 16. In the main plane of the valve membrane, the valve membrane portions 22 have a much greater width than the oblique reinforcement bodies 20. For example, the valve membrane portions 22 adjoin the reinforcement structure 16 at half the height thereof. Alternatively, these are joined to the reinforcement structure 16 in a bottom region or head region of the reinforcement structure 16.

The valve membrane 11 is configured overall like a leaf with the reinforcement structure 16. The connection web 19 forms a central rib, while the oblique reinforcement bodies 20 form side ribs. Thus, the valve membrane 11 on the whole follows bionic principles.

The connection web 19 and the oblique reinforcement bodies 20 give the valve membrane 11 stability. The comparatively thin valve membrane portions 22 act as predetermined bending points or predetermined kinking points and reduce the kink resistance.

The minimum thickness of the reinforcement structure 16 is determined by a requirement concerning the minimum stiffness of the valve membrane 11. This is chosen such that, even with the valve membrane 11 sloping downward, the valve membrane 11 still bears on the valve seat body 8 in a fluid-tight manner or closes the valve seat opening 9 in a fluid-tight manner and does not sag.

As has already been mentioned, the valve membrane 11 in its release position is lifted away from the valve seat body 8 at a distance from its clamping site, such that the valve seat opening 9 is freed and the wearer's breath can flow through the valve seat opening 9. The valve membrane 11 then expediently has a bending line, which runs between the sides 15 of the valve membrane 11. The bending line preferably extends at a distance from the clamping site or base 14 of the valve membrane 11 and at a distance from the tip 18 of the valve membrane 11, wherein the bending line preferably runs or is arranged closer to the clamping site than to the tip 18. The bending line preferably intersects the central plane or plane of symmetry 12 of the valve membrane. Overall, the bending line runs between the sides 15 preferably substantially in a V-shape or curved, wherein a bending line base preferably lies on the central plane or plane of symmetry 12 of the valve membrane, and the bending line runs obliquely forward from there and/or away from the base 14.

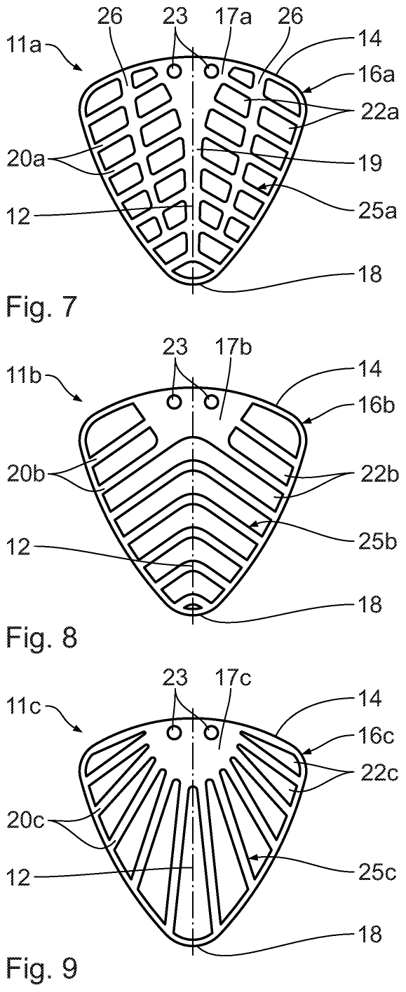

A second embodiment of the valve membrane is described below with reference to FIG. 7. Identical parts or components are given the same reference signs as in the preceding embodiment, to which reference is hereby made. Parts or components which are structurally different but functionally equivalent are given the same reference signs but with the suffix “a”.

Compared to the valve membrane 11 already described, the reinforcement structure 16a in the valve membrane 11a shown in FIG. 7 is of a different configuration. The reinforcement structure 16a has two additional auxiliary reinforcement webs 26, which run from the base 14 in the direction of the tip 18. However, the auxiliary reinforcement webs 26 end at a distance from the tip 18. They run gradually together from the base 14 but terminate at a distance from each other at two oblique reinforcement bodies 20a. The auxiliary reinforcement webs 26 divide the valve membrane portions 22a into subsidiary portions, which can have identical or different sizes. Between five and fifteen V-shaped reinforcement arrangements 25a are present. Two are joined to the connection panel 17a.

A third embodiment of the valve membrane is described below with reference to FIG. 8. Identical parts or components are given the same reference signs as in the first embodiment, to which reference is hereby made. Parts or components which are functionally equivalent but structurally different are given the same reference signs but with the suffix

The reinforcement structure 16b in the valve membrane 11b according to FIG. 8 is of a different configuration. The connection web 19 is missing as it were. Most of the individual V-shaped reinforcement arrangements 25b are thus connected to each other only via the frame body 21 or the valve membrane portions 22b. These run at a distance from each other. The valve membrane portions 22b between individual V-shaped reinforcement arrangements 25b are contiguous. Between five and fifteen V-shaped reinforcement arrangements 25b are present in total. Two are joined to the connection panel 17b.

A fourth embodiment of the valve membrane is described below with reference to FIG. 9. Identical parts or components are given the same reference signs as in the first embodiment, to which reference is made. Parts or components which are functionally equivalent but structurally different are given the same reference signs but with the suffix “c”.

The reinforcement structure 16c in this valve membrane 11c is also of a different configuration. There is no connection web 19. The connection panel 17c has a substantially semicircular shape. The oblique reinforcement bodies 20c extend out from the connection panel in a radiating pattern. They run obliquely to the base 14. Adjacent oblique reinforcement bodies 20c also extend away from each other. The oblique reinforcement bodies 20c are arranged in pairs with respect to the central plane 12 of the valve membrane and form corresponding V-shaped reinforcement arrangements 25c. Between five and fifteen V-shaped reinforcement arrangements 25c are present.

The bending behavior of the valve membranes 11a, 11b, 11c according to FIGS. 7 to 9 is preferably substantially identical to the bending behavior of the valve membrane 11 according to the first embodiment.

While specific embodiments of the invention have been shown and described in detail to illustrate the application of the principles of the invention, it will be understood that the invention may be embodied otherwise without departing from such principles.

1. A valve membrane for a breathing mask the valve membrane comprising:
a reinforcement structure with a plurality of oblique reinforcement bodies extending obliquely with respect to a central plane of the valve membrane, wherein at least two of the oblique reinforcement bodies each extend together in a V shape so as to form at least one V-shaped reinforcement arrangement, wherein a plurality of V-shaped reinforcement arrangements are present, wherein at least two of the V-shaped reinforcement arrangements are connected to each other via at least one reinforcement connection body of the reinforcement structure lying in the central plane of the valve membrane, wherein the reinforcement connection body is formed by a central connection web, the valve member being triangle-shaped.

2. The valve membrane as claimed in claim 1, further comprising valve membrane portions adjoining the reinforcement structure.

3. The valve membrane as claimed in claim 2, wherein at least some of the valve membrane portions, in a main plane of the valve membrane, are broader at least in part than at least one respective oblique reinforcement body.

4. The valve membrane as claimed in claim 1, further comprising at least one predetermined bending point in one of areas comprising an area spaced from the reinforcement structure and an area adjacent to the reinforcement structure.

5. The valve membrane as claimed in claim 1, wherein the reinforcement structure defines at least one predetermined bending point of the valve membrane.

6. The valve membrane as claimed in claim 1, wherein the reinforcement structure comprises a frame body completely surrounding the valve membrane.

7. The valve membrane as claimed in claim 1, wherein the reinforcement connection body is formed by a central connection panel that extends at an edge.

8. The valve membrane as claimed in claim 1, wherein at least two of the V-shaped reinforcement arrangements are connected via at least one auxiliary reinforcement web extending at a distance from the central plane of the valve membrane.

9. The valve membrane as claimed in claim 1, wherein the oblique reinforcement bodies have portions extending obliquely with respect to each other.

10. The valve membrane as claimed in a claim 1, wherein the oblique reinforcement bodies have reinforcement portions extending parallel to each other.

11-12. (canceled)

13. The valve membrane as claimed in claim 2, wherein the valve membrane portions, perpendicular to a main plane of the valve membrane, are each thinner than the reinforcement structure.

14. A breathing mask for filtering air exhaled by a wearer of the breathing mask, the breathing mask comprising:
a mask main body for covering a nose and mouth of the wearer; and
at least one breathing valve arrangement arranged on the mask main body, the at least one breathing valve arrangement comprising a valve seat body and a valve membrane movable between a release position and a closed position, the valve membrane being triangle-shaped, wherein the valve membrane frees at least one breathing opening in the release position, the valve membrane closing the at least one breathing opening in the closed position, the valve membrane comprising a reinforcement structure having a plurality of oblique reinforcement bodies extending obliquely with respect to a central plane of the valve membrane, wherein at least two of the oblique reinforcement bodies each extend together in a V shape so as to form at least one V-shaped reinforcement arrangement, wherein a plurality of the V-shaped reinforcement arrangements are present, at least two of the V-shaped reinforcement arrangements being connected to each other via at least one reinforcement connection body of the reinforcement structure lying in the central plane of the valve membrane, the reinforcement connection body being formed by a central connection web.

15. The breathing mask as claimed in claim 14, wherein the valve membrane is clamped in part at an edge between the valve seat body and a housing body.
